(19) United States
(12) Patent Application Publication
(10) Pub. No.: US 2025/0189398 A1
(43) Pub. Date: Jun. 12, 2025

(54) METHOD FOR MONITORING THE COHERENCE OF AN ATMOSPHERIC PRESSURE VALUE USED FOR CONFIGURING FLIGHT INSTRUMENTS OF AN AIRCRAFT

(71) Applicant: Airbus Operations SAS, TOULOUSE (FR)

(72) Inventors: Patrice ROUQUETTE, TOULOUSE (FR); Benoît DAZET, TOULOUSE (FR); Joris SCATTOLIN, TOULOUSE (FR); Antoine AÏT-AKKOUCHE, TOULOUSE (FR)

(21) Appl. No.: 18/971,896

(22) Filed: Dec. 6, 2024

(30) Foreign Application Priority Data
Dec. 8, 2023 (FR) 2313847

(51) Int. Cl. G01L 27/00; G01L 13/00; G01L 19/12

(52) U.S. Cl. CPC G01L 27/002; G01L 13/00; G01L 19/12

(57) ABSTRACT

A method for monitoring the coherence of an atmospheric pressure value to be used for configuring flight instruments of an aircraft includes: interrogating a database to obtain an altitude value of a selected airport; obtaining a static pressure value, a static temperature value, and a geometric altitude value, corresponding to a current situation of the aircraft; deducing therefrom an estimate of a static pressure value at the selected airport; evaluating a coherence level between the estimate and the atmospheric pressure value to be used for configuring the flight instruments of the aircraft; and generating a warning if the coherence level is below a predefined threshold.

### CROSS-REFERENCES TO RELATED APPLICATIONS

This application claims the benefit of the French patent application No. 2313847 filed on Dec. 8, 2023, the entire disclosures of which are incorporated herein by way of reference.

### FIELD OF THE INVENTION

The present invention relates to the monitoring of the coherence of a QFE or QNH atmospheric pressure value (typically input by the aircraft pilot into a human-machine interface of flight instruments of the aircraft), which is to be used for configuring the flight instruments of an aircraft.

### SUMMARY OF THE INVENTION

In barometric navigation, an aircraft is guided by using a barometric vertical position (altitude) based on isobaric/barometric pressure lines. This barometric navigation can be used in all phases of flight (climb, cruise, descent and approach). The barometric altitude is calculated with respect to a reference atmospheric pressure. Above a reference altitude (called the “transition altitude” in climbing, and called the “transition flight level” in descent), the reference atmospheric pressure in question is 1013 hPa. Below this reference altitude, the reference atmospheric pressure is either equal to the atmospheric pressure measured at the level of the destination airfield/airport (the reference atmospheric pressure is then designated by the international code “QFE”), or equal to the atmospheric pressure measured at the level of the destination airfield/airport and then converted to sea level (the reference atmospheric pressure is then designated by the international code “QNH”).

Below the transition altitude, or transition flight level, the QNH or QFE atmospheric pressure value is more important, because it directly affects the vertical position of the aircraft and consequently its trajectory in level flight, in climbing, or in descent and approach. A QFE or QNH atmospheric pressure value is input by the pilot via a human-machine interface of the flight instruments of the aircraft, such as an EFISCP (Electronic Flight Instrument System Control Panel) for example, immediately before passing through the transition altitude or the transition flight level.

There is a known method, notably as disclosed in patent application US2008/243316A1, for monitoring the coherence of an atmospheric pressure value to be used for configuring flight instruments of an aircraft.

Thus, it is desirable to provide a solution for monitoring the QFE or QNH atmospheric pressure value, which is input by the pilot, and for automatically generating a warning if the input value appears erroneous.

### SUMMARY OF THE INVENTION

What is proposed here is a method for monitoring the coherence of an atmospheric pressure value to be used for configuring flight instruments of an aircraft, the method being executed by a monitoring system in the form of electronic circuitry, the method comprising the following steps: interrogating a database supplying reference information on a set of airports, and obtaining in return an altitude value of a selected airport; obtaining a static pressure value, a static temperature value, and a geometric altitude value of the aircraft, these values corresponding to a current situation of the aircraft; making an estimate of a static pressure value at the selected airport, on the basis of the static pressure value, the static temperature value and the geometric altitude value of the aircraft, which correspond to the current situation of the aircraft, and on the basis of the altitude of the selected airport that was obtained by interrogating the database; evaluating a coherence level between the estimate of the static pressure value at the selected airport and the atmospheric pressure value to be used for configuring the flight instruments of the aircraft; and generating a warning if the coherence level is below a predefined threshold.

Also proposed here is a monitoring system configured for monitoring the coherence of an atmospheric pressure value to be used for configuring the flight instruments of an aircraft, the monitoring system comprising electronic circuitry configured for: interrogating a database supplying reference information on a set of airports, and obtaining in return an altitude value of a selected airport; obtaining a static pressure value, a static temperature value, and a geometric altitude value of the aircraft, these values corresponding to a current situation of the aircraft; making an estimate of a static pressure value at the selected airport, on the basis of the static pressure value, the static temperature value and the geometric altitude value of the aircraft, which correspond to the current situation of the aircraft, and on the basis of the altitude of the selected airport that was obtained by interrogating the database; evaluating a coherence level between the estimate of the static pressure value at the selected airport and the atmospheric pressure value to be used for configuring the flight instruments of the aircraft; and generating a warning if the coherence level is below a predefined threshold.

Also proposed here is an aircraft comprising the above monitoring system.

### BRIEF DESCRIPTION OF THE DRAWINGS

The abovementioned characteristics of the invention, along with others, will become more clearly apparent on reading the following description of at least one example of embodiment, the description being given with reference to the appended drawings, in which:

FIG. 1 illustrates schematically an algorithm for monitoring the coherence of a QFE or QNH atmospheric pressure value to be used for configuring the flight instruments of an aircraft;

FIG. 2 illustrates schematically a context for the use of a monitoring system comprising electronic circuitry configured for executing the method of FIG. 1; and

FIG. 3 illustrates schematically a hardware platform adapted for implementing the monitoring system.

### DETAILED DESCRIPTION OF THE PREFERRED EMBODIMENTS

What is proposed here, and detailed in different embodiments below, is the making of an estimate of static pressure at a selected airport, which may be a departure airport or a destination airport, for an aircraft, on the basis of:
a static pressure value, a static temperature value, and a geometric altitude value, for example a GPS (Global Positioning System) altitude, which are supplied by flight instruments of an aircraft;
an altitude of the selected airport, as obtained from a database supplying reference information on a set of airports.

In the remainder of the description, the selected airport will be considered to be a destination airport, but the same steps are applicable to a departure airport.

In a non-limiting manner, the geometric altitude may be obtained from a radio altitude (RA) with an airfield database, or from a hybrid IRS (Inertial Reference System)/GPS system.

It is then proposed to evaluate whether information representative of a QFE or QNH atmospheric pressure value to be used for configuring flight instruments of the aircraft (this value being typically input by the aircraft pilot into a human-machine interface of the flight instruments of the aircraft) is coherent with the static pressure estimate that has been made. If a sufficient coherence level (threshold) is not reached, a warning is generated.

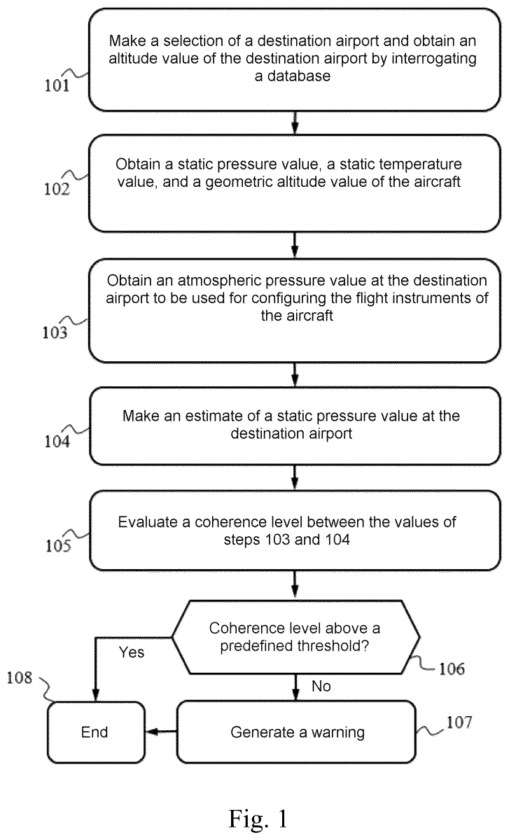

Thus FIG. 1 illustrates schematically an algorithm for monitoring the coherence of a QFE or QNH atmospheric pressure value to be used for configuring the flight instruments of an aircraft.

The algorithm illustrated schematically in FIG. 1 is implemented by a system, called a monitoring system, in the form of electronic circuitry, embodiments of which are described below with reference to FIG. 3. This monitoring system is preferably integrated with the avionics of the aircraft, forming part of a system of the FWS (Flight Warning System) type, for example.

In a step 101, the monitoring system makes a selection of a destination airport. For example, a human-machine interface of the flight instruments of the aircraft displays a list of a number of candidate destination airports and the pilot selects a destination airport from this list. According to another example, the pilot inputs an airport name into a human-machine interface of the flight instruments of the aircraft. According to yet another example, avionics equipment of the aircraft automatically determines a destination airport (e.g., a diversion airport).

Then, on the basis of the selection of the destination airport, the monitoring system interrogates a database that supplies reference information on a set of airports (the name of the airport, its geographical coordinates, its altitude relative to sea level, etc.). In return, the system obtains an altitude value for the destination airport, as previously stored for reference in the database in question.

In a step 102, the monitoring system obtains a static pressure value, a static temperature value, and a geometric altitude value of the aircraft. These values correspond to the current situation of the aircraft and are supplied by flight instruments of an aircraft.

In a step 103, the monitoring system obtains a QFE or QNH atmospheric pressure value at the destination airport, which is to be used for configuring flight equipment of the aircraft.

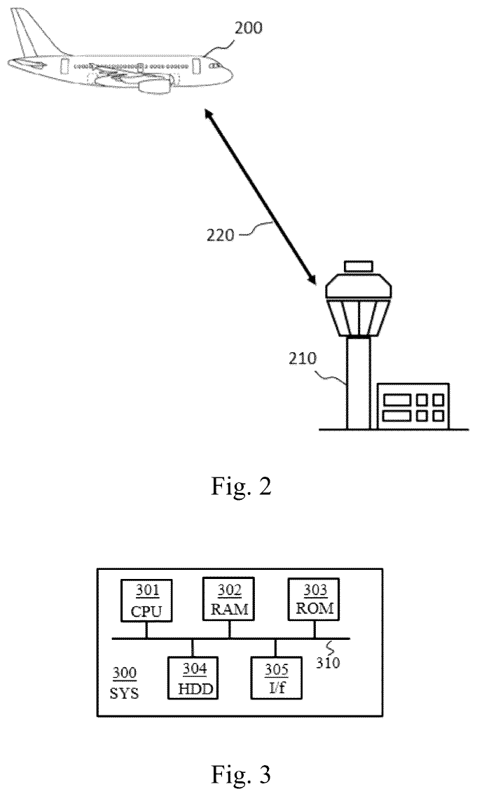

In a particular embodiment, as illustrated schematically in FIG. 2, the atmospheric pressure value is received by air-to-ground communication 220 from a control center of the destination airport 210 to the aircraft 200. The value received in this way is input by the pilot of the aircraft 200 into a human-machine interface of the flight instruments of the aircraft 200. The aircraft 200 includes the monitoring system, which then carries out the monitoring of the value thus input by the pilot.

Accordingly, in a step 104, the monitoring system makes an estimate of a static pressure value at the destination airport selected in step 101. The estimate is made on the basis of the static pressure value, the static temperature value and the geometric altitude value of the aircraft, which were obtained in step 102, and on the basis of the altitude of the destination airport that was obtained by interrogating the database in step 101.

More precisely, in a particular embodiment, the monitoring system obtains in advance an estimate Tₑₛₜᵢₘ of the static temperature at the destination airport, using the following formula:

$${T}_{estim} = {T}_{A / C \_ STAT} + ( ( {Z}_{A / C} - {Z}_{A} ) * {K}_{T} )$$

where:
TA/C_STAT is the static temperature value that was obtained in step 102;
Z_{A/C} is the geometric altitude value of the aircraft that was obtained in step 102;
ZA is the altitude of the destination airport that was obtained in step 101;
KT is a coefficient of temperature gradient, which is either the temperature gradient of the standard atmosphere, or comes from a database storing temperature gradient information originating from meteorological statistics for geographical areas, the coefficient KT then being selected from this database according to the date when the calculation is performed and the geographical position of the destination airport.

For a departure airport, it is assumed that Z_{A/C} is equal to Z_{A}, and therefore that the difference (Z_{A/C}−Z_{A}) is zero, and therefore that Tₑₛₜᵢₘ is equal to TA/C_STAT.

The system then obtains the estimate Pₑₛₜᵢₘ of the static pressure at the destination airport, using the following formula or an approximation thereof:

$${P}_{estim} = {P}_{A / C \_ STAT} * {( \frac{( ( {Z}_{A / C} - {Z}_{A} ) * {K}_{T} )}{{T}_{estim}} + 1 )}^{\frac{g}{{K}_{T} * R}}$$

or therefore, in an equivalent manner,

$${P}_{estim} = {P}_{A / C \_ STAT} * {( \frac{( ( {Z}_{A / C} - {Z}_{A} ) * {K}_{T} )}{{T}_{A / C \_ STAT} + ( ( {Z}_{A / C} - {Z}_{A} ) * {K}_{T} )} + 1 )}^{\frac{g}{{K}_{T} * R}}$$

where:
PA/C_STAT is the static pressure value that was obtained in step 102; and
g represents the gravitational acceleration and R represents the specific constant of dry air.

For a departure airport, it is assumed that Z_{A/C} is equal to Z_{A}, and therefore that Pestim is equal to PA/C_STAT.

An approximation may be obtained by limited expansion, or by polynomial regression, or by linear interpolation.

In a step 105, the monitoring system evaluates a coherence level between the values of steps 103 and 104. Thus, in a particular embodiment, the monitoring system evaluates the coherence level between the estimated value (step 104) and the value (QNH or QFE) input by the pilot (step 103).

In a step 106, the monitoring system checks whether the coherence level evaluated in step 105 is greater than or equal to a predefined threshold. If this is the case, a step 108 is executed, in which the algorithm of FIG. 1 is stopped. The atmospheric pressure value obtained in step 103 (and typically input by the aircraft pilot) can then be used for configuring the flight instruments of the aircraft. Otherwise (if the coherence level is below the predefined threshold), before the execution of step 108, a step 107 is executed, in which a warning (visual and/or audible in the aircraft cockpit, for example) is generated. The pilot is responsible for performing the routine checks required as a result, before confirming or rejecting the atmospheric pressure value to be used for configuring the flight instruments of the aircraft.

Different embodiments of steps 105 and 106 are described below.

In a first embodiment, the system calculates an estimate QNHₑₛₜᵢₘ of atmospheric pressure of the QNH type, on the basis of the estimated static pressure at the destination airport Pₑₛₜᵢₘ and on the basis of the altitude value ZA of the destination airport obtained in step 101:

$${QNH}_{estim} = {H}_{std}^{- 1} ( {H}_{std} ( {P}_{estim} ) - {Z}_{A} )$$

where H_{std} represents the standard function of barometric altitude as a function of the static pressure (standard atmosphere), and H_{std}⁻¹ represents the inverse function of H_{std}.

The system then calculates a difference QNH_{Diff} in atmospheric pressure value QNH between the estimate QNHₑₛₜᵢₘ and an atmospheric pressure value QNH_{IN} (of the QNH type) obtained in step 103:

$${QNH}_{Diff} = \vert {QNH}_{estim} - {QNH}_{IN} \vert \\ therefore \\ {QNH}_{Diff} = \vert {H}_{std}^{- 1} ( {H}_{std} ( {P}_{estim} ) - {Z}_{A} ) - {QNH}_{IN} \vert$$

In this first embodiment, this difference QNH_{Diff} of atmospheric pressure value defines the coherence level between the values of steps 103 (QNH_{IN}) and 104 (Pₑₛₜᵢₘ). The coherence level decreases as the difference QNH_{Diff} increases. The monitoring system then compares the difference QNH_{Diff} with a first predefined threshold TH_{QNH}, and, if the difference QNH_{Diff} is above the first predefined threshold TH_{QNH} (insufficient coherence level), a warning is generated.

In a second embodiment, the monitoring system calculates a first difference in altitude Z_{delta} between a value Z_{calc} of a standard function of barometric altitude which is obtained on the basis of the estimated static pressure at the destination airport Pₑₛₜᵢₘ, and the altitude value Z_{A} of the destination airport which was obtained in step 101:

$${Z}_{delta} = {Z}_{calc} - {Z}_{A} = {H}_{std} ( {P}_{estim} ) - {Z}_{A}$$

The monitoring system then calculates a second difference in altitude Z_{Diff} between the first difference in altitude Z_{delta} and an altitude value deduced, using the aforementioned function H_{std}, from an atmospheric pressure value QNH_{IN} (of the QNH type) obtained in step 103:

$${Z}_{Diff} = \vert {Z}_{delta} - {H}_{std} ( {QNH}_{IN} ) \vert$$

In this second embodiment, this second difference in altitude Z_{Diff} defines the coherence level between the values of steps 103 (QNH_{IN}) and 104 (Pₑₛₜᵢₘ). The coherence level decreases as this second difference in altitude Z_{Diff} increases. The monitoring system then compares the second difference in altitude Z_{Diff} with a second predefined threshold TH_{STD}, and, if the second difference in altitude Z_{Diff} is above the second predefined threshold TH_{STD} (insufficient coherence level), a warning is generated. In a third embodiment, the monitoring system calculates an estimate of the barometric altitude Zₑₛₜᵢₘ of the destination airport on the basis of the estimated static pressure at the destination airport Pₑₛₜᵢₘ and on the basis of an altitude value deduced from an atmospheric pressure value QNH_{IN} (of the QNH type) obtained in step 103:

$${Z}_{estim} = {H}_{std} ( {P}_{estim} ) - {H}_{std} ( {QNH}_{IN} )$$

The monitoring system calculates a difference Z′_{Diff} between the estimate of the barometric altitude Zₑₛₜᵢₘ and the barometric altitude deduced from the altitude value Z_{A} of the destination airport obtained in step 101:

$${Z}_{Diff}^{′} = \vert {Z}_{estim} - {Z}_{A} \vert$$

In this third embodiment, this difference in altitude Z′_{Diff} defines the coherence level between the values of steps 103 (QNH_{IN}) and 104 (Pₑₛₜᵢₘ). The coherence level decreases as this difference in altitude Z′_{Diff} increases. The monitoring system then compares the difference in altitude Z′_{Diff} with a third predefined threshold TH_{ALT}, and, if the difference in altitude Z′_{Diff} is above the third predefined threshold TH_{ALT} (insufficient coherence level), a warning is generated.

In a fourth embodiment, the system calculates a static pressure value P′_{STAT} at the destination airport on the basis of an atmospheric pressure value QNH_{IN} obtained in step 103 and on the basis of the altitude value Z_{A} of the destination airport obtained in step 101:

$${P}_{STAT}^{′} = {H}_{std}^{- 1} ( {H}_{std} ( Q N {H}_{IN} ) + {Z}_{A} )$$

The system calculates a difference Ps_{Diff} in static pressure on the basis of the static pressure value P′_{STAT} thus obtained and the estimated static pressure Pₑₛₜᵢₘ at the destination airport:

$${Ps}_{Diff} = \vert {P}_{STAT}^{′} - {P}_{estim} \vert$$

In this fourth embodiment, this difference Ps_{Diff} in static pressure defines the coherence level between the values of steps 103 (QNH_{IN}) and 104 (Pₑₛₜᵢₘ). The coherence level decreases as this difference Ps_{Diff} in static pressure increases. The monitoring system then compares the difference Ps_{Diff} in static pressure with a fourth predefined threshold TH_{Ps}, and, if the difference Ps_{Diff} in static pressure is above the fourth predefined threshold TH_{Ps} (insufficient coherence level), a warning is generated.

In a fifth embodiment, a static pressure value QFE_{IN} (of the QFE type) is obtained in step 103 (being typically input by the pilot of the aircraft). The monitoring system then calculates a difference between the input static pressure value QFE_{IN} and the estimated static pressure Pₑₛₜᵢₘ at the destination airport.

$${Ps}_{Diff} = \vert Q F {E}_{IN} - {P}_{estim} \vert$$

In this fifth embodiment, this difference Ps_{Diff} in static pressure defines the coherence level between the values of steps 103 (QFE_{IN}) and 104 (Pₑₛₜᵢₘ). The coherence level decreases as this difference Ps_{Diff} in static pressure increases. The monitoring system then compares the difference Ps_{Diff} in static pressure with the aforementioned fourth predefined threshold TH_{Ps}, and, if the difference Ps_{Diff} in static pressure is above the fourth predefined threshold TH_{Ps} (insufficient coherence level), a warning is generated.

The aforementioned thresholds TH_{QNH}, TH_{STD}, TH_{ALT} and TH_{Ps} are determined upstream so as to represent an acceptable margin of potential error regarding the QFE or QNH atmospheric pressure value, used for configuring the flight instruments of the aircraft.

FIG. 3 illustrates schematically a hardware platform SYS 300 adapted for implementing the monitoring system and executing the method of the algorithm of FIG. 1.

The hardware platform SYS 300 then comprises the following, connected by a communication bus 310: a processor or CPU (Central Processing Unit) 301; a random access memory RAM (Random Access Memory) 302; a read-only memory 303, of the ROM (Read Only Memory) or EEPROM (Electrically-Erasable Programmable ROM) type, for example, or of the Flash type; a storage unit such as a hard disk HDD (Hard Disk Drive) 304, or a storage medium reader such as an SD (Secure Digital) card reader; and an interface controller I/f 305.

The interface controller I/f 305 enables the hardware platform SYS 300 to interact with peripherals such as human-machine interface peripherals (for input, display, warning signal broadcast, etc.) and flight instruments of the aircraft.

The processor 301 is capable of executing instructions loaded into the random access memory 302 from the read-only memory 303, from an external memory, from a storage medium (such as an SD card), or from a communication network. When the hardware platform SYS 300 is switched on, the processor 301 can read instructions from the random access memory 302 and execute them. These instructions form a computer program causing the processor 301 to implement some or all of the steps and methods described here.

Some or all of the steps and methods described here may thus be implemented in software form by the execution of a set of instructions by a programmable machine, such as a processor of the DSP (Digital Signal Processor) type or a microcontroller, or may be implemented in hardware form by a machine or a dedicated electronic component (or “chip”) or a dedicated set of electronic components (or “chipset”). In general terms, the monitoring system thus comprises electronic circuitry adapted and configured to implement the steps and methods described here.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for monitoring a coherence of an atmospheric pressure value to be used for configuring flight instruments of an aircraft, the method being executed by a monitoring system comprising electronic circuitry, the method comprising the following steps:
interrogating a database supplying reference information on a set of airports, and obtaining in return an altitude value of a selected airport;
obtaining a static pressure value, a static temperature value, and a geometric altitude value of the aircraft, these values corresponding to a current situation of the aircraft;
making an estimate of a static pressure value at the selected airport, based on the static pressure value, the static temperature value and the geometric altitude value of the aircraft, which correspond to the current situation of the aircraft, and based on the altitude value of the selected airport that was obtained by interrogating the database;
evaluating a coherence level between the estimate of the static pressure value at the selected airport and the atmospheric pressure value to be used to configure the flight instruments of the aircraft; and
generating a warning if said coherence level is below a predefined threshold.

2. The method according to claim 1, wherein the estimation of the static pressure value at the selected airport Pₑₛₜᵢₘ is such that:
$${P}_{estim} = {P}_{A / C \_ STAT} * {( \frac{( ( {Z}_{A / C} - {Z}_{A} ) * {K}_{T} )}{{T}_{A / C \_ STAT} + ( ( {Z}_{A / C} - {Z}_{A} ) * {K}_{T} )} + 1 )}^{\frac{g}{{K}_{T} * R}}$$
where: TA/C_STAT is the static temperature value corresponding to the current situation of the aircraft, Z_{A/C} is the geometric altitude value of the aircraft corresponding to the current situation of the aircraft, PA/C_STAT is the static pressure value corresponding to the current situation of the aircraft, Z_{A} is the altitude value of the selected airport that was obtained by interrogating the database, KT is a temperature gradient coefficient, g is gravitational acceleration, and R is a specific constant of dry air.

3. The method according to claim 2, wherein, for carrying out the estimation of the static pressure value at the selected airport, the method comprises:
obtaining an estimate Tₑₛₜᵢₘ of the static temperature value at the selected airport, using the following formula:
$${T}_{estim} = {T}_{A / C \_ STAT} + ( ( {Z}_{A / C} - {Z}_{A} ) * {K}_{T} )$$
obtaining the estimate Pₑₛₜᵢₘ of the static pressure value at the selected airport, using the following formula or an approximation thereof:
$${P}_{estim} = {P}_{A / C \_ STAT} * {( \frac{( ( {Z}_{A / c} - {Z}_{A} ) * {K}_{T} )}{{T}_{estim}} + 1 )}^{\frac{g}{{K}_{T} * R}} .$$

4. The method according to claim 1, wherein, for evaluating said coherence level, the method comprises the following steps:
calculating an estimate QNHₑₛₜᵢₘ of atmospheric pressure of a QNH type, based on the estimated static pressure value at the selected airport and based on the altitude value Z_{A/C} of the selected airport:
$$Q N {H}_{estim} = {H}_{std}^{- 1} ( {H}_{std} ( {P}_{estim} ) - {Z}_{A} )$$
where H_{std}(Pₑₛₜᵢₘ) represents a standard function of barometric altitude as a function of the estimated static pressure value at the selected airport, and H_{std}⁻¹ represents the inverse function of H_{std};
calculating a difference QNH_{Diff} in atmospheric pressure value between the estimate QNHₑₛₜᵢₘ and the atmospheric pressure value, of the QNH type, to be used for configuring the flight instruments of the aircraft QNH_{IN}:
$$Q N {H}_{Diff} = \vert Q N {H}_{estim} - Q N {H}_{IN} \vert$$
comparing the difference QNH_{Diff} with a predefined threshold TH_{QNH}, and, if the difference QNH_{Diff} is above the predefined threshold TH_{QNH}, the warning is generated by the monitoring system.

5. The method according to claim 1, wherein, for evaluating said coherence level, the method comprises the following steps:
calculating a first difference in altitude Z_{delta} between a value Z_{calc} of a standard function of barometric altitude which is obtained based on the estimated static pressure value at the selected airport Pₑₛₜᵢₘ, and the altitude value Z_{A/C} of the selected airport which was obtained by interrogating the database:
$${Z}_{delta} = {Z}_{calc} - {Z}_{A} = {H}_{std} ( {P}_{estim} ) - {Z}_{A}$$
where H_{std}(Pₑₛₜᵢₘ) represents the standard function of barometric altitude as a function of the estimated static pressure value at the selected airport;
calculating a second difference in altitude Z_{Diff} between the first difference in altitude Z_{delta} and an altitude value deduced from the atmospheric pressure value, of a QNH type, to be used for configuring the flight instruments of the aircraft QNH_{IN}:
$${Z}_{Diff} = \vert {Z}_{delta} - {H}_{std} ( Q N {H}_{IN} ) \vert$$
comparing the second difference in altitude Z_{Diff} with a predefined threshold TH_{STD}, and, if the second difference in altitude Z_{Diff} is above the predefined threshold TH_{STD}, the warning is generated by the monitoring system.

6. The method according to claim 1, wherein, for evaluating said coherence level, the method comprises the following steps:
calculating an estimate of barometric altitude value Zₑₛₜᵢₘ of the selected airport based on the estimated static pressure value at the selected airport Pₑₛₜᵢₘ and based on an altitude value deduced from the atmospheric pressure value, of a QNH type, to be used for configuring the flight instruments of the aircraft QNH_{IN}:
$${Z}_{estim} = {H}_{std} ( {P}_{estim} ) - {H}_{std} ( Q N {H}_{IN} )$$
where H_{std} represents the standard function of barometric altitude value as a function of the static pressure value;
calculating a difference Z′_{Diff} between the estimate of the barometric altitude value Zₑₛₜᵢₘ and a value of barometric altitude deduced from the altitude value Z_{A} of the selected airport:
$${Z}_{Diff}^{′} = \vert {Z}_{estim} - {Z}_{A} \vert$$
comparing the difference in altitude Z′_{Diff} with a predefined threshold TH_{ALT}, and, if the difference in altitude Z′_{Diff} is above the predefined threshold TH_{ALT}, the warning is generated by the monitoring system.

7. The method according to claim 1, wherein, for evaluating said coherence level, the method comprises the following steps:
calculating a static pressure value P′_{STAT} at the selected airport based on the atmospheric pressure value of a QNH type to be used for configuring the flight instruments of the aircraft QNH_{IN} and based on the altitude value Z_{A} of the selected airport:
$${P}_{STAT}^{′} = {H}_{std}^{- 1} ( {H}_{std} ( Q N {H}_{IN} ) + {Z}_{A} )$$
where H_{std} represents a standard function of barometric altitude as a function of the static pressure value, and H_{std}⁻¹ represents an inverse function of H_{std};
calculating a difference Ps_{Diff} in static pressure value based on the static pressure value P′_{STAT} thus calculated and the estimated static pressure value Pₑₛₜᵢₘ at the selected airport:
$${Ps}_{Diff} = \vert {P}_{STAT}^{′} - {P}_{estim} \vert$$
comparing the difference Ps_{Diff} in static pressure value with a predefined threshold TH_{Ps}, and, if the difference Ps_{Diff} in static pressure value is above the predefined threshold TH_{Ps}, the warning is generated by the monitoring system.

8. The method according to claim 1, wherein, for evaluating said coherence level, the method comprises the following steps:
calculating a difference between the atmospheric pressure value, of a QFE type, to be used for configuring the flight instruments of the aircraft QFE_{IN} and the estimated static pressure value Pₑₛₜᵢₘ at the selected airport:
$${Ps}_{Diff} = \vert {QFE}_{IN} - {P}_{estim} \vert$$
comparing a difference Ps_{Diff} in static pressure value with a predefined threshold TH_{Ps}, and, if the difference Ps_{Diff} in static pressure value is above the predefined threshold TH_{Ps}, the warning is generated by the monitoring system.

9. The method according to claim 1, wherein the atmospheric pressure value to be used for configuring the flight instruments of the aircraft is input by a pilot of the aircraft into a human-machine interface of the flight instruments of the aircraft.

10. A monitoring system configured for monitoring a coherence of an atmospheric pressure value to be used for configuring flight instruments of an aircraft, the monitoring system comprising electronic circuitry configured to:
interrogate a database supplying reference information on a set of airports, and obtaining in return an altitude value of a selected airport;
obtain a static pressure value, a static temperature value, and a geometric altitude value of the aircraft, these values corresponding to a current situation of the aircraft;
make an estimate of a static pressure value at the selected airport, based on the static pressure value, the static temperature value and the geometric altitude value of the aircraft, which correspond to the current situation of the aircraft, and based on the altitude of the selected airport that was obtained by interrogating the database;
evaluate a coherence level between said estimate of the static pressure value at the selected airport and the atmospheric pressure value to be used for configuring the flight instruments of the aircraft; and
generate a warning if said coherence level is below a predefined threshold.

11. An aircraft comprising the monitoring system according to claim 10.
